(19) United States
(12) Patent Application Publication
(10) Pub. No.: US 2007/0020497 A1
(43) Pub. Date: Jan. 25, 2007

(54) Direct fuel cell system

(75) Inventors: Okuyama Ryoichi, Osaka (JP); Fujimatsu Masakatsu, Osaka (JP); Watanabe Tsutomu, Osaka (JP); Nakamura Satoru, Osaka (JP); Motoi Masashi, Osaka (JP); Nomura Eiichi, Osaka (JP)

Correspondence Address: THE WEBB LAW FIRM, P.C., 700 KOPPERS BUILDING, 436 SEVENTH AVENUE, PITTSBURGH, PA, 15219, US

(73) Assignee: GS YUASA CORPORATION, KYOTO, SHIMOGYO-KU, KYOTO-SHI (JP)

(21) Appl. No.: 10/555,601

(22) PCT Filed: Mar. 29, 2004
(86) PCT No.: PCT/JP04/04477

§ 371 Date: Nov. 4, 2005

(30) Foreign Application Priority Data
May 7, 2003 (JP) 2003-128656
Jul. 25, 2003 (JP) 2003-201831
Sep. 30, 2003 (JP) 2003-341123
Oct. 31, 2003 (JP) 2003-372070

(51) Int. Cl. H01M 8/10; H01M 8/24; H01M 8/04

(52) U.S. Cl. 429/32; 429/38; 429/22

(57) ABSTRACT

A direct methanol fuel cell is provided in a fuel tank, and a liquid fuel is supplied to a fuel electrode with convection through a duct which vertically passes through a surface of a separator. Air is supplied to a duct for air supply, the duct being provided to the separator, from a blower.

### FIELD OF THE INVENTION

The present invention relates to a direct fuel cell system employing a liquid fuel type cell in which a fuel such as methanol, ethanol, isopropanol or butanol is mixed with water and the mixed fuel is directly supplied to a fuel electrode. This invention particularly relates to a direct fuel cell system in which a fuel is supplied to a liquid fuel type cell in a natural manner through the use of convection or the like.

### DESCRIPTION OF THE PRIOR ART

In a methanol direct fuel cell system, methanol is supplied to a direct fuel cell system using a methanol-water mixed fuel in the range of 1-10 wt % without reforming the methanol into hydrogen. Since a methanol direct fuel cell system does not need a reforming device, it is simple in structure and light. Therefore, in particular, a scaled-down methanol direct fuel cell system is promising for power sources used for electronics such as mobile phones, video cameras, personal computers and the like, for power sources used for the outdoors, for backup power sources and the like.

In a direct fuel cell system, since it is necessary to control the supplying of a fuel to a cell stack using a fuel pump, the system becomes complex. When an output is excessively taken out from a cell stack that is dipped in a liquid fuel, an electrode, which is connected to a proton conductive solid polymer electrolyte membrane, could be damaged. Furthermore, since the cell stack is immersed in the liquid fuel, it becomes necessary to prevent damaging of a proton conductive solid polymer electrolyte membrane and an electrode due to short circuits or electrolytic corrosions. Moreover, in order to make the system to be scaled down, it is required to make it easy to use a liquid fuel.

Patent Literature 1: Japanese Patent Application Laid-open No. 2003-100315(EP 1296400A2)

Patent Literature 2: Japanese Patent Application Laid-open No. 2002-343378(U.S. Publication 20020172853A1)

In Patent Literature 1, there is disclosed a cell structure where a plurality of cells each being in monolithic shape are adhered the surface of a fuel tank. In Patent Literature 2, there is disclosed a structure where air electrodes are disposed on the outside of a hollow fuel tank.

### SUMMARY OF THE INVENTION

A main object of the present invention is to simplify the supplying of a fuel in a direct fuel cell system and to particularly eliminate the use of a fuel pump for fuel supply from a fuel tank to a cell stack.

Another object of the present invention is to enable controlling the direct fuel cell system so that it can properly output in response to a required load and to prevent irreversible degradation of a fuel cell.

A further object of the present invention is to eliminate the necessity of adjusting the height of the liquid surface in a fuel tank using a level meter, a pump or the like and to make it easy to discharge CO₂ from the fuel tank.

Yet another object of the present invention is to make it easy to activate a direct fuel cell system.

A still further object of the present invention is to make it possible to activate a direct fuel cell system even if it is located at an inclined position.

An additional object of the present invention is to make it possible to recover excess water from a direct fuel cell system or produced water on an air electrode without a dedicated waste liquid tank and thereby to scale down the direct fuel cell system.

Further objects of the present invention are described as follows:
to make it possible to more securely recover water content contained in waste air into a fuel cassette;
to form a waste liquid reservoir in a fuel cassette whereby the fuel cassette is usefully used; and
to maintain the liquid surface in a fuel tank within a predetermined range.

Secondary objects of a fuel cassette in the present invention are described as follows:
to make it easy to recover water contents into a fuel cassette and at the same time to make it possible to securely process excess water contents;
to make it possible to easily check the remaining amount of a fuel in a fuel cassette; and
to make it easy to detach a fuel cassette.

In the present invention, there is provided a direct fuel cell system where a cell stack is formed by serially connecting a plurality of unit cells with separators, each unit cell being formed by a proton conductive solid polymer electrolyte membrane on one face of which a fuel electrode is provided and on the other face of which an air electrode is provided, in a way that a separator is interposed between the unit cells, the cell stack being operable with a liquid fuel, in which the cell stack is disposed in a fuel tank so that at least part of the cell stack is submerged under a liquid surface of the liquid fuel in the fuel tank; a duct for fuel supply is provided to a surface of the separator on the side of the fuel electrode thereof, both ends of the duct being placed to be submerged under the liquid surface of the liquid fuel to be communicated with the liquid fuel, the liquid fuel in the fuel tank being naturally supplied to the fuel electrode; and a duct for air supply is provided to a surface of the separator on the side of the air electrode thereof.

It is preferable that an exhaust part is provided to a top face of the fuel tank; carbon dioxide being produced on the fuel electrode is discharged through the exhaust part; and air outside the fuel tank is supplied to the air electrode from a blower or a fan. Hereinafter, when only a blower is referred, it means both of a blower and a fan.

It is preferable that, depending on an operation condition of the fuel cell, an amount of air being supplied from the blower or the fan is controlled with a control device.

It is preferable that the amount of supplying air of a blower or a fan is controlled that an output voltage if the fuel cell is maintained to be equal to or more than a predetermined value. In particular, the amount of air is increased when an output voltage is lowered.

In the present invention, the cell stack is placed so that it is submerged in the fuel cell of the fuel tank, and the fuel is supplied to a fuel electrode with convection or the like. Carbon dioxide being produced on fuel electrode is discharged through an exhaust part provided to the top part of the fuel tank. Therefore a pump for fuel supply to the cell stack is not necessary whereby the system becomes compact and it is not necessary to have a vapor-liquid separator which separates carbon dioxide from the liquid fuel.

By supplying air to the side of an air electrode from a blower or a fan, a larger output can be obtained compared to that by a natural air supply. Further, when a load increases or when the condition of the fuel cell is worsened, the amount of supplying air is controlled to be increased for preventing polarity reversal. The polarity reversal is a irreversible phenomenon in which the potential of the fuel electrode reverses into positive to the potential of the air electrode; and the potential of the fuel electrode becomes equal to or higher than the potential of Ru whereby Ru in the fuel electrode elutes into the fuel.

It is preferable that an exhaust pipe for discharging exhaust from the outlet side of the duct of the separator for air supply to the outside of the fuel tank is provided, exhaust from the exhaust pipe being heat exchanged, and, on the basis of a liquid level in the fuel tank, water being recovered through the heat exchange is either discharged in a water tank or is returned into the fuel tank.

When the recovered water is not returned to the fuel tank, the liquid surface level is lowered since the fuel and the water in the fuel tank are brought out of the system by exhaust. In order to compensate this, it is necessary to resupply high concentration methanol and water. When the recovering of water is completely performed, it is necessary to frequently discharge the fuel from the fuel tank since the liquid surface rises in the fuel tank. This is troublesome, and attention must be also paid since the remaining fuel contains formic acid, formaldehyde and the like.

On the other hand, by liquefying vapor in the exhaust and by returning part or all of the liquefied water into the fuel tank, a constant liquid surface level can be maintained in the fuel tank. Therefore, the amount of the resupplying fuel to the fuel tank can be minimized, hence eliminating the necessity of directly disposing the fuel from the fuel tank.

It is preferable that an air supply pipe for supplying air from the blower or the fan to the separator is provided and valves are provided respectively to the exhaust pipe and the air supply pipe whereby the respective valves close when a fuel cell stops so that the ducts of the cell stack for air supply are maintained to be airtight.

With the duct of the cell stack for air supply not to be airtight, when the fuel cell is left in the liquid fuel while not operating it, the fuel is infiltrated to the air electrode side. When activating the system in this state, it becomes necessary to discharge the fuel having been infiltrated into the air electrode side, which is however a difficult work. When the ducts are arranged for example in matrix, the fuel tends to remain somewhere inside. Using the ducts not arranged in matrix still requires the blower or the fan to have an excessively high capability in air supply. Moreover, when air and a large quantity of fuel exit at the same time, the temperature of the electrode tends to unnecessarily increase.

On the other hand, when the valves are closed while the fuel cell is inoperative so as to cause the ducts of the cell stack for air supply to be airtight, it is possible to minimize the filtration of the fuel into the air electrode side, hence making the activation easy.

It is preferable that an air pipe and a valve for performing bubbling of air into the fuel of the fuel tank from the bottom of the cell stack are provided and air is supplied to the ducts of the cell stack for fuel supply in cold starting. With both ends of the ducts for fuel supply submerged in the liquid fuel, when the bubbling is performed for example in the vicinity of the bottom face of the cell stack, air enters the ducts for fuel supply. Moreover, cold starting means one in which for example a room temperature or the temperature of the liquid fuel is equal to or less than 0 degree centigrade or 10 degrees centigrade. However, specific temperature can be properly selected depending on the characteristic of the fuel cell.

When activating in a cold region, it is necessary to increase the temperature of the fuel cell at a time of the starting of an operation. In this case, when performing bubbling of air in the fuel tank so as to supply the air to the fuel electrode, the air thus produced causes the fuel electrode to generate heat and thereby an easy activation is made possible. Since the air pipe has a valve, it may be stayed closed except the time of activation.

It is preferable that a gas space, which remains above the liquid surface in the fuel tank, is provided and a plurality of exhaust parts, being placed at different horizontal positions, are provided to top part of the fuel tank so that at least one of the exhaust pipes contacts with the gas space when the fuel tank is inclined. The exhaust part is an air duct or the like which is made using a liquid-impermeable and vapor-permeable membrane or which is in coil shape. Carbon dioxide and the like are discharged through the gas space.

When the exhaust part contacts with the gas space only at one place, it could be submerged at worst under the liquid surface when the fuel tank is inclined. Consequently, it becomes difficult to discharge carbon dioxide through the exhaust part, which causes the inside of the fuel tank to be unnecessarily pressurized, hence resulting in the occurrence of leakage or the like. However, when a plurality of exhaust parts are provided, at least one of them remains above the liquid surface through which carbon dioxide can be discharged even when the fuel tank is inclined. Here, “inclination of the fuel tank” means slightly inclining the fuel tank from the horizontal level. The angle of inclination of the fuel tank is, for example, in the range of ±15 degrees, preferably ±10 degrees, or of ±5 degrees as the smallest one.

It is preferable that the ducts for fuel supply are placed in two dimension on the surface of the separator on the side of the fuel electrode thereof.

It is more preferable that the separator is made long in the lateral direction, and the length in the horizontal direction is larger than the height.

When the fuel tank is inclined with all of the ducts, for example, pointed in the vertical direction, a fuel discharge end on the upper side of the fuel tank, in some cases, comes out of the liquid surface. In this case, the fuel does not flow in such a duct, which causes the duct not to work as a normal one. On the other hand, when the ducts are arranged in two dimension, it becomes possible to minimize the number of the ducts where the fuel does not flow; and it is possible to increase a movable range when the fuel tank is inclined and thereby it becomes possible to supply the fuel to the fuel electrode even when the tank is inclined.

In the supplying of air to an air electrode, both ends of a duct for air supply are connected to the atmosphere, and thereby air may be led into the cell stack with natural ventilation.

It is preferable that the cell stack is entirely dipped in the liquid fuel.

It is preferable that both ends of the duct for air supply and both ends of the duct for fuel supply are provided on different surfaces of the cell stack. It is specially preferable that both ends of the duct for fuel supply are placed on both of the top and bottom faces of the cell stack and both ends of the duct for air supply are placed on both side faces of the cell stack.

It is preferable that the fuel tank also works as a housing for the cell stack.

It is preferable that a resupply opening for liquid fuel is provided to the fuel tank.

It is preferable that the liquid fuel is methanol aqueous solution.

In the present invention, carbon dioxide produced on a fuel electrode is discharged into the fuel tank, movement of which generates a convection that makes it possible to supply the liquid fuel to the side of the fuel electrode with no intermittence. When part of the cell stack is dipped in the liquid fuel, the fuel can be supplied with capillarity action in addition to the convection of the liquid fuel. When both ends of the duct for air supply and both ends of the duct for fuel supply are placed on different faces of the cell stack, air and the fuel can be supplied without being mixed each other. Further, by providing a resupply opening for the liquid fuel in the fuel tank, when the concentration in the fuel tank is lowered, a fresh liquid fuel can be resupplied and thereby a continuous operation is made possible.

In order to cause air to be distributed in the duct for air supply, an open part which is open to the atmosphere may be provided to the fuel tank, or an inner manifold structure may be provided to the cell stack whereby air is supplied to the duct for air supply from the inner manifold.

It is preferable that the liquid fuel is a mixture of organic solvent and water, and is added with no acid. It is more preferable that the liquid fuel is methanol aqueous solution without acid. In a liquid fuel without acid, since the conductivity of the liquid fuel is low, it is possible to prevent an electrode or the like from being damaged by electric corrosion which is induced by an electric field generated by the cell stack.

It is preferable that a member which is active carbon, zeolite or the like is caused to contact with the fuel, and adsorbs or decomposes acid such as formic acid produced by a side reaction, and also adsorbs or decomposes a hazardous substance such as formaldehyde.

It is also preferable that an insulation member is provided so as to protrude out of an edge of the cell stack, specially, preferably, out of the four edges of the cell stack so that liquid junction and damage to an electrode or the like are prevented. The insulation member is a packing which is provided between the separator and the electrode.

It is preferable that the fuel is resupplied to the fuel tank from the fuel cassette, and a fuel reservoir and a waste liquid reservoir are provided to the fuel cassette so that water, which is brought out of the air electrode of the fuel cell together with waste air, is recovered into the waste liquid reservoir. In consequence, since water in the liquid fuel which is supplied from the fuel cassette together with methanol, isopropanol, dimethylether and the like, and a water content produced on the air electrode can be recovered into the fuel cassette, it is possible to eliminate the fuel tank or scale it down. Since an exchange of the fuel cell allows the resupplying of the fuel and the processing of waste liquid such as produced water, it becomes simple to use.

It is preferable that air is supplied to the air electrode from the blower or the fan, and a pressure from the blower or the fan the pressure acting on the waste air from the air electrode is used to recover a water content into the waste liquid reservoir of the fuel cassette. Since providing of only the waste liquid reservoir on a fuel electrode does not make recovering of the water content any easy, it may be considered that, by providing a waste liquid pump, the water content is supplied to the waste liquid reservoir. On the other hand, a blower or a fan is used to and a discharge structure for waste air is provided in the waste liquid reservoir, whereby the water content can be supplied to the waste liquid reservoir with the use of a pressure from the blower or the fan the pressure having remained on the side of the outlet of the air electrode.

It is preferable that part of the water content being recovered into the waste liquid reservoir of the fuel cassette, or impurity being contained in the waste air is processed with a chemical filter and is thereafter evaporated or discharged to the outside. The chemical filter is for example an active carbon. It is also possible to use zeolite, silica gel or the like for the filter. On these filters, an oxidation catalyst such perovskite, titanium oxide, platinum black or the like is supported and used, or such an oxidation catalyst may be singly used to process recovered water content or to process remaining methanol, formic acid, formaldehyde, methyl formate and the like. While the chemical filter in the embodiment was provided in the duct for evaporating water content, it may be provided in the waste liquid reservoir and is dipped therein. Use of the chemical filter makes it possible to safely process recovered impurities and thus the recovering of water content becomes easy.

It is preferable that a device for discharging waste air from the waste liquid reservoir is provided.

It is preferable that, depending on the liquid surface level in the fuel tank, the water being brought out of the air electrode together with the waste air is selectively recovered either into the waste liquid reservoir of the fuel cassette or into the fuel tank. As a result waste liquid reservoir works as a buffer for maintaining a constant liquid surface level in the fuel tank, which is therefore capable of easily maintaining the liquid surface in the fuel tank within a predetermined range.

It is preferable that a vapor-liquid separator for separating water content from the waste air from the air electrode is provided, and the water liquefied through the separation having being carried out using the vapor-liquid separator is recovered into the waste liquid reservoir of the fuel cassette. The vapor-liquid separator has a preferably structure which allows the separator to preserve a certain amount of water. Without performing a vapor-liquid separation, for example, all the waste air may be led to the waste liquid reservoir so as to discharge all but a water content. It is, however, becomes necessary to separate the water content and the air in the waste liquid reservoir. The waste air increases the temperature of the waste liquid reservoir, and it becomes complex for sealing in preventing the leakage of the fuel and the evaporation thereof and, particularly, for sealing a connecting part (connector) connecting to the direct fuel cell system. When the waste air from which the water content is separated is not even refluxed to the fuel tank, it is still preferable that the waste air is processed with the chemical filter such as active carbon and is discharged after removing methanol evaporation or the like.

It is especially preferable that the fuel cell is submerged in the fuel of the fuel tank; part of water content in the waste air from the air electrode is refluxed into the fuel tank via the vapor-liquid separator; and a gas outlet is provided to the fuel tank whereby carbon dioxide is discharged from the fuel electrode. In consequence, the fuel is supplied naturally and uniformly to each cell with the use of a convection of the fuel in the fuel tank. In addition, the fuel cell stack and the fuel tank are integrated, hence contributing to the omitting of the space. By using the water which is refluxed to the fuel tank from the vapor-liquid separator, the liquid level can be stably maintained.

In the present invention, furthermore, in a fuel cassette for a direct fuel cell system, a fuel reservoir being freely connectable to the direct fuel cell system and a waste liquid reservoir for storing waste water from the direct fuel cell system are provided, and part of water content being recovered in the waste liquid reservoir or impurity being contained in waste air is processed with a chemical filter and is thereafter evaporated.

By recovering the water content from the side of the direct fuel cell system into the fuel cassette, a specialized waste liquid tank can be eliminated or can be scaled down. The fuel concentration in the fuel reservoir of the fuel cassette is, for example, in the range of 20-100 wt %, preferably 40-100 wt %. When the fuel is assumed to be methanol-water and the methanol concentration of the fuel reservoir is, for example, 30 wt %, the fuel from the fuel reservoir contains methanol and water where the volume ratio of methanol-to-water is approximately 1:2 and the molar ratio thereof is approximately 1:4. Oxidizing of 1 mole of methanol causes the following reactions.
CH₃OH+H₂O→6H⁺+CO₂+6e (Fuel Electrode)
6H⁺+6e⁻+3/2O₂ →3H₂O (Air Electrode)
On the side of the air electrode, 3 mole of vapor is produced. However, in fact, considering that proton moves in a proton conductive solid polymer electrolyte membrane in hydronium ion (H₃O⁺), neglecting a crossover of the methanol and the water, and neglecting also the evaporation of water content on any other place than on the air electrode, then, to 1 mole of methanol, water content which is discharged to the air electrode is approximately 9 mole, 4 mole of which corresponds to the water in the fuel, 2 mole of which corresponds to water from hydrogen atom in methanol. Then, assuming that the methanol concentration of fuel reservoir is for example 30 wt %, when ⅔ of the water content from the air electrode is recovered into the waste liquid reservoir and ⅓ thereof is recovered to the fuel tank, the methanol concentration in the fuel tank can be maintained constant. Assuming that the methanol concentration of fuel reservoir is for example 20 wt %, when all of the water content from the air electrode is recovered into the fuel tank and no water content is recovered into the fuel tank, the methanol concentration in the fuel tank can be maintained constant. As has been described above, it is preferable that, depending on the liquid concentration of the fuel tank, the ratio of the amount of water content recovered into the waste liquid reservoir, the water content being brought out of the air electrode, and the amount thereof recovered into the fuel tank is so determined that the fuel concentration in the fuel tank stays constant. Moreover, the space in the waste liquid reservoir after the liquid fuel in the fuel cassette is completely expended becomes larger in volume than the amount of waste liquid, the waste liquid being produced by a reaction of the liquid fuel and air. Hence, it is possible to retain in the space all but carbon dioxide and part of water content to be discharged.

It is preferable that a viewing window is provided to a case of the fuel cassette so as to check the fuel reservoir with eyes. For example, an elastic bag or a flexible bag is provided in the fuel reservoir and is colored, or a movable partition is provided between the waste liquid reservoir and the fuel reservoir, so that the bag and the partition can be checked with eyes through a viewing window. Alternatively, the bag is made transparent, and the fuel is colored instead with coloring matter and colorant. In this case, since the proton conductive solid polymer electrolyte membrane does not allow the coloring matter and colorant to permeate therethrough, the waste liquid reservoir is not colored. In any case, the remaining amount of fuel can be easily checked with eyes using color.

It is preferable that a swing guide for detaching from and loading on the direct fuel cell system is provided in the fuel cassette. Thus, a guide member on the side of the direct fuel cell system and a guide of the fuel cassette are engaged so as to swing, whereby the detaching and loading of the fuel cassette becomes easy.

It is preferable that a concavity/convexity part, which works as a hook when detaching from the direct fuel cell system, is provided in the fuel cassette. Here, the concavity/convexity part indicates a protrusion over which a user can hook his/her finger, a concavity against which a user to press down his/her finger, or a plurality of numbers of concavity parts and convexity parts. The concavity/convexity part is so disposed that it is exposed out of the direct fuel cell system when the fuel cassette is loaded on the system. This allows a user to easily detach the fuel cassette from the direct fuel cell system.

### BRIEF DESCRIPTION OF THE DRAWINGS

FIG. 1 is a vertical fragmentary cross-sectional view showing an embodiment of a direct fuel cell system in which air is supplied with a blower or a fan;

FIG. 2 is a front view (Left side: a fuel electrode side) and a back view (Right side: an air electrode side) of a separator used in the embodiment;

FIG. 3 is a perspective view showing the structure of end plates of a cell stack used in the embodiment;

FIG. 4 is a front view (Left side: a fuel electrode side) and a back view (Right side: an air electrode side) of a separator used in a modified embodiment;

FIG. 5 is a schematic view showing an upper part of a tank in a state where the direct fuel cell system of the embodiment is vertically inclined;

FIG. 6 is a schematic view showing a modified example of the direct fuel cell system;

FIG. 7 is a schematic view showing bubbling to a fuel electrode at a time of activation;

FIG. 8 is a schematic view in loading on a case of the system a high concentration methanol tank and a water tank;

FIG. 9 is a side elevation view of the direct fuel cell system in the modified embodiment;

FIG. 10 is a schematic view showing an example of a cell structure of the direct fuel cell system of the embodiment, in which air is naturally supported;

FIG. 11 is a schematic view showing an example of the cell stack;

FIG. 12 is a partial-cutaway perspective view of the direct fuel cell system of the embodiment;

FIG. 13(a) is a cross-sectional viewtaken along line A-A in FIG. 12;

FIG. 13(b) is a cross-sectional view taken along line B-B in FIG. 12;

FIG. 14 is a schematic view showing an embodiment of the direct fuel cell system which uses a fuel cassette.

FIG. 15 is a cross-sectional view of a fuel cassette of the embodiment;

FIG. 16 is a cross-sectional view of a fuel cassette of the modified embodiment;

FIG. 17 is a cross-sectional view of a fuel cassette of another embodiment;

FIG. 18 is a cross-sectional view of a fuel cassette of still another embodiment;

FIG. 19 is a cross-sectional view of a fuel cassette of another embodiment;

FIG. 20 is a cross-sectional view of a fuel cassette of other embodiment;

FIG. 21 is a schematic view showing the connecting of the direct fuel cell system and the fuel cassette of the embodiment through a hollow needle;

FIG. 22 is a schematic view showing the connecting of the direct fuel cell system and the fuel cassette of the embodiment through a valve;

FIG. 23 is a cross-sectional view showing the loading of the fuel cassette of the embodiment on the direct fuel cell system;

FIG. 24 is a view showing a guide of the fuel cassette to the direct fuel cell system;

FIG. 25 is a view showing a guide of the fuel cassette to the direct fuel cell system;

FIG. 26 is a perspective view showing the loading of the direct fuel cell system, having housed the fuel cassette of the embodiment, on a personal computer;

FIG. 27 is a perspective view of the fuel cassette of the embodiment;

FIG. 28 is a perspective view of the direct fuel cell system and the fuel cassette of the embodiment;

FIG. 29 is a cross-sectional view of the direct fuel cell system having housed the fuel cassette of the embodiment; and

FIG. 30 is a partial-cutaway perspective view of a direct fuel cell system of a forth embodiment.

### DESCRIPTION OF THE PREFERRED EMBODIMENTS

First Embodiment

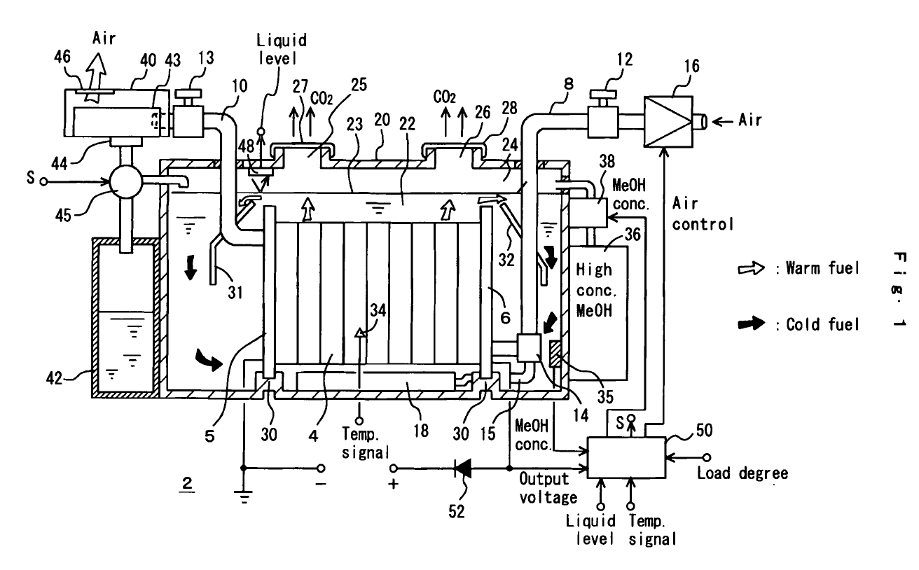

FIGS. 1 to 8 shows an embodiments and modifications thereof. In the figures, reference numeral 2 denotes a direct fuel cell system in which a cell stack 4 comprising fuel cells being liquid fuel types are disposed in a fuel tank 20. Reference numerals 5 and 6 respectively denote end plates, which are disposed on both sides of the cell stack 4. Reference numeral 8 denotes an air pipe and reference numeral 10 denotes an exhaust pipe. Reference numerals 12 to 14 denote valves. An air pipe 15 is connected to the air pipe 8 through the valve 14. Reference numeral 16 denotes a blower for supplying air to the air pipe 8. Reference numeral 18 denotes a bubbling mat, which is provided below the cell stack 4 and connected to the air pipe 15, the bubbling mat being one such as a porous mat which is breathable.

Reference numeral 20 denotes a fuel tank. For the material of the fuel tank 20, plastic where liquid fuels such as polypropylene, polyimide, polyphenylenesulfide, and methanol do not permeate is used. A methanol-water fuel 22 is housed in the tank. The fuel is not necessarily the methanol-water, but may be an isopropanol-water, a butanol-water, or the like. Reference numeral 23 denotes the liquid surface of the methanol-water fuel (hereinafter referred to as liquid fuel). The level of the liquid surface is made such that, in the fuel tank 20, a gas space 24 is provided above the liquid surface 23. In this manner, waste air and carbon dioxide from an air electrode of the cell stack 4 are stayed in the gas space 24. Reference numerals 25 and 26 denote exhaust outlets. These exhaust outlets 25 and 26 are provided at positions higher than those of the top faces of other parts in the fuel tank 20, and contact with the gas space 24. It is preferable that the exhaust outlets 25 and 26 are plurally provided on the top face of the fuel tank 20. For example, in the embodiments, these exhaust outlets 25 and 26 are provided at two positions along the center line in the longitudinal direction of the top face of the fuel tank 20. On the top parts of the exhaust outlets 25 and 26, hydrophobic porous membranes 27 and 28 are respectively provided so that only gas is discharged without letting the fuel permeate therethrough. For each of the hydrophobic porous membranes 27 and 28, a membrane such as a porous polytetrafluoroethylene membrane is used, and any membrane may be used so long as it only lets gas permeate therethrough without letting liquid i.e., water permeate. If the permeability for the hydrophobic porous membranes 27 and 28 can be given a selection, it is preferable to select one where the permeability of water content is low; and the permeability of alcohol, carboxylic acid, aldehyde, and ether is also low.

Fixing parts 30 and 30 or the like are provided to the bottom of the fuel tank 20 on the upper faces thereof. The end plates 5 and 6 of the cell stack 4 are fixed to the fixing parts 30 and 30 so that the cell stack 4 can be placed thereon. For the fixing, for example, the end plates 5 and 6 are fitted into groves provided at the fixing parts 30, 30, and are further hot-sealed thereafter with an adhesive material or are preferably fastened with screws and bolts made of plastic or the like which is insulative and corrosive resistant to the liquid fuel. Reference numerals 31 and 32 denote current plates. The liquid surface 23 of the fuel is made located a little higher than the top parts of the current plates 31 and 32; and these plates 31 and 32 restrict the flow of the liquid fuel in a way that the liquid fuel flows through the upper side of the cell stack 4 to the outside thereof. Therefore, the liquid fuel whose relative density becomes small because the temperature increases after passing through the cell stack 4 moves through the plates 31, 32 to a position far from the cell stack 4 in a wraparound manner. The liquid fuel, then, goes down to the bottom of the fuel tank 20 while being gradually cooled down, and refluxed to the bottom face of the cell stack 4.

Reference numeral 34 denotes a temperature sensor. The sensor 34 is disposed in the cell stack 4 or the like. This sensor 34 is used to detect a state in the cell stack 4 and to detect an approximate temperature of the system when it starts activating in the cold. Reference numeral 35 denotes a methanol sensor. The methanol sensor 35 is used to measure the methanol concentration of the liquid fuel 22, and is disposed at any place. Meanwhile, the sensors 34 and 35 are not necessarily disposed. Reference numeral 36 denotes a tank for a high concentration of methanol. The tank 36 reserves, for example, a high concentration methanol fuel such as a methanol 50 wt %-water 50 wt %, which is supplied to the fuel tank 20 via a methanol pump 38. Further, a standard concentration of the liquid fuel 22 is, for example, 3wt %-5wt % of methanol.

The exhaust pipe 10 is made in a way that waste air is cooled down outside the valve 13 after passing through a heat exchanger 40; and liquefied water by the cooling is discharged into the fuel tank 20 or a water tank 42 via the valve 45 with a backflow valve 44, which is placed below a drain 43 having a vapor-liquid separation membrane. The waste air after removing the water is discharged outside the system through an exhaust outlet 46 having been provided with a water-repellent membrane. A liquid level sensor 48 is disposed in the fuel tank 20 and is used to detect the liquid level in the fuel tank. A liquid level signal from the liquid level sensor 48 is input into a control unit 50 and the valve 45 is switched using a valve signal S. When the liquid level is higher than a predetermined value, water is discharged into the water tank 42 without returning to the fuel tank 20. For other cases, water is returned into the fuel tank 20. The liquid level sensor 48 determines the height of a liquid surface using a supersonic wave, a reflection of light, or the like. In addition, the liquid level sensor 48 is put at any place. For the heat exchanger 40, one that is designed to discharge heat into circumambient air using a fan may be employed. For cooling, airflow may be a natural one, while, for example, it may also be one generated by a fan. When a direct fuel cell system 2 is used as a power source for a personal computer, the heat exchanger 40 may be, for example, cooled down using a fan for a CPU.

Reference numeral 50 denotes a control unit. Reference numeral 52 denotes a diode for protection and may not be necessarily provided. The control unit 50 activates the methanol pump 38 in response to a methanol concentration signal from the methanol sensor 35, and adjusts the concentration of methanol in the fuel tank 22. Further, when the pump is for example activated in the cold, not greater than 10 degree centigrade to be precise, in response to a temperature signal, a part of air is bubbled from the bubbling mat 18 with the valve 14 and this air is led to a fuel electrode via a duct for a fuel, the duct being provided to a separator. Then, the bubbled air and the fuel at the fuel electrode directly react, thus generating heat. An amount of air for bubbling is controlled by a fuel temperature.

The control unit 50 monitors an output voltage and the like of the cell stack 4. However, when signals with respect to the extent of a load from a loading side and the like are obtained, the output voltage is corrected using these signals whereby the state of the cell stack 4 is monitored. The direct fuel cell system 2 has a secondary battery not shown as a backup other than this cell stack, which is used for activation.

The direct fuel cell system has polarity reversal as a problem peculiar to itself. The polarity reversal is a phenomenon discovered by the inventors. The phenomenon is one that, when the potential of a fuel electrode is for example 500 mV or more than 500 mV higher in positive than that of an air electrode within the same unit cell, Ru in the Pt-Ru of a fuel electrode catalyst elutes into the fuel. An electrode material of the fuel electrode is one in which C is caused to support an a catalyst comprising Ru such as Pt-Ru, a binder such as PTFE(polytetrafluoroethylene) is added, and a desired amount of proton conductive solid polymer electrolyte is added whereby the extent of hydrophobicity-hydrophilicity is controlled. The reason why Ru is added on the side of the fuel electrode is to prevent the degradation of the characteristic due to CO adsorption when oxidizing methanol or the like in the fuel. Furthermore, an electrode material on the side of the air electrode is, for example, one in which a PTFE binder and a proton conductive solid polymer electrolyte are added to an electrode catalyst where C is caused to support Pt. For the electrode catalyst on the air electrode, Pt-Ru, Pt-Rh and the like are also used other than Pt. These electrode materials are known. Moreover, Nafion membrane (Nafion is the registered trademark by E.I. du Pont de Nemours and Company) is used for the proton conductive solid polymer electrolyte membrane between the fuel electrode and the air electrode. This membrane is known. On a surface opposite to the proton conductive solid polymer electrolyte membrane for the fuel electrode and the air electrode, a breathable carbon sheet or the like is disposed, and thereby the supplying of fuel and air and current-collecting are controlled.

The cell stack is different from a fuel cell made of a hydrogen fuel in that a fuel electrode is exposed to an electrolytic solution. As for a methanol-water fuel, for example, acid such as formic acid is produced due to the incomplete oxidization of methanol. The experiment where the inventors conducted showed that, when the direct fuel cell system 2 was operated for a long period of time, pH of the liquid fuel 22 was lowered to the extent of 3. Further, since formaldehyde and the like are also contained in the liquid fuel 22, it is preferable not to discharge it from the fuel tank 20 to the outside by causing it to be cyclically used as much as possible, thereby avoiding to discharge the formic acid and the formaldehyde to the outside of the system.

The liquid fuel is weakly electrolytic, and if a potential on the side of the liquid fuel takes a large positive value compared to that on the side of the air electrode while the liquid fuel remains to have the above mentioned property, the potential of the fuel electrode exceeds the elution potential of Ru whereby Ru is eluted into the fuel. The inventors confirmed this phenomenon through the observation where, when the potential of the fuel electrode becomes 500 mV or more than 500 mV higher in positive than that of the air electrode, Ru is detected in the waste fuel and the cell, which once underwent the elution of Ru, was able to obtain only a small output concentration even when returning the potential to the normal one.

Next, in the cell stack 4, a plurality of unit cells are serially connected. It is preferable that, in place of simply connecting unit cells in serial, the extent of 2-4 unit cells are connected in parallel as one unit and a plurality of such units are connect in serial. In the cell stack 4, since a plurality of unit cells are connected in serial, current which corresponds to an output current for the entire cell stack 4 flows through a unit cell, even if the unit cell is not in a bad state. Hence, for a unit cell which is in lack of fuel or air, a potential on the side of the fuel electrode especially tends to be in positive, and if the system is forced to activate under such condition, a polarity reversal occurs.

In the embodiments, however, when an output voltage of the cell stack 4 is monitored with the control unit 50 and the extent of a load is known, a correction is made to the output voltage depending on the extent of the load where an amount of supplied air of the blower 16 is controlled so that an output voltage, which is equal to or more than a predetermined one, is obtained. When increasing an amount of supplied air, a polarity reversal in each unit cell becomes hard to occur, thereby preventing the occurrence of a polarity reversal. When a predetermined output voltage is not obtained even if an amount of supplied air is increased, the direct fuel cell system 2 is stopped. As another idea for preventing a polarity reversal, an increase in the methanol concentration in the liquid fuel 22 may be considered. However, in that case, since a control by the methanol pump 38 is slow in response, it is not so effective in preventing a polarity reversal. Therefore, it is necessary to prevent a polarity reversal by controlling the blower 16 whereby an amount of air is controlled so that an output voltage, which is equal to or more than a predetermined one is obtained from the cell stack 4. As an auxiliary means other than that, in the fuel 22, a circulating pump is provided at a top part, a bottom part or the like of the cell stack 4 so that, when an output voltage of the cell stack 4 is lowered, the pump may be activated to speed up the circulation of the fuel.

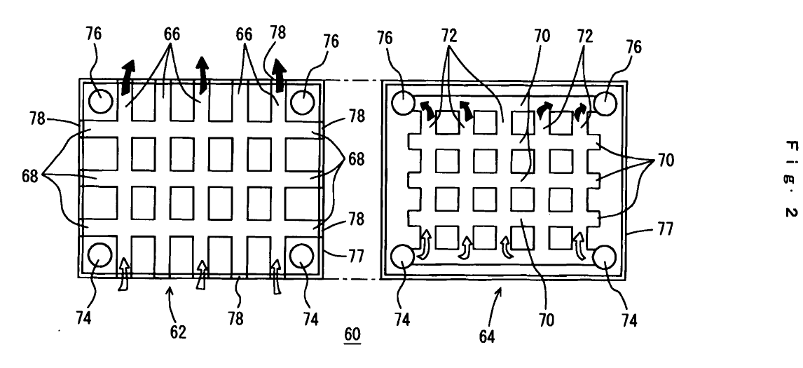

In FIG. 2, there are shown ducts which are provided to a surface 62 (left side) of the separator 60 on the side of a fuel electrode and to a surface 64 (right side) thereof on the side of an air electrode. For the material of the separator 60, for example, carbon in which resin is added is used. Other than that, a titanium plate or a stainless steel plate may also be used. The separator 60 is made long in the lateral direction, and is made larger in width in the horizontal direction than the height so that it makes a fuel supply easy through the use of a natural convention or the like. On the surface 62 on the side of the fuel electrode, a plurality of vertical ducts 66 and a preferably plurality of horizontal ducts 68 are provided. These ducts are arranged in matrix, i.e. in two dimension. It is also possible to incline the vertical ducts 66 and the horizontal ducts 68. However, such inclination to the ducts is not preferable since it makes the length of a duct longer, thereby causing a fuel supplying capability to be lowered. On the surface 64 on the side of the air electrode, a plurality of vertical ducts 72 and a preferably plurality of horizontal ducts 70 are provided so that air supplied from an air supply opening 74 is led to an exhaust opening 76.

Since the cell stack 4 is used in the liquid fuel 22 which is weakly electrolytic, it is necessary to prevent the occurring of short-circuit. Therefore, for example, a resin cover 77 made of insulative plastic is provided on a side face of the separator 60. Reference numeral 78 denotes a groove; and a portion, which is an inlet/an outlet for the ducts 66, 68 on the surface 62 on the side of the fuel electrode, is covered with the cover 77.

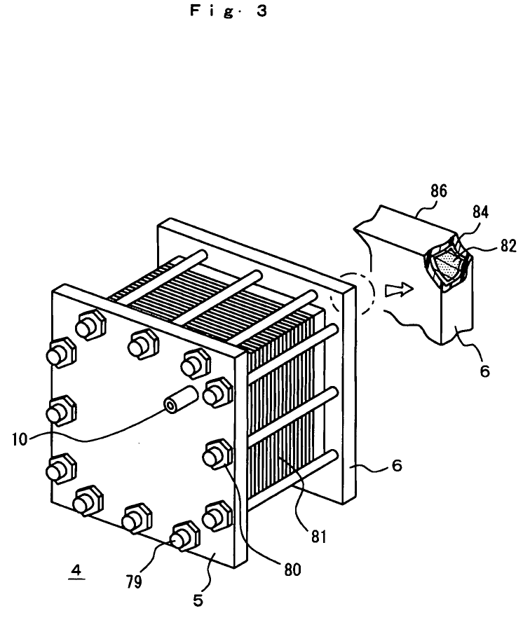

In FIG. 3, reference numerals 79 and 80 respectively denote a bolt and a nut. These bolt and nut may be made of synthetic resin for preventing short-circuit and improving corrosion resistance. Reference numeral 81 schematically shows each unit cell. As previously described, a plurality of unit cells are connected in serial through a separator whereby the cell stack 4 is formed.

In the present embodiments, the end plate 6 is made to work as a fastening plate. In addition, since the plate is also made to work as a collector plate, a material having conductivity is used. Its constitution is shown in upper right of FIG. 3. For example, a carbon plate 82 using carbon, an object made by modeling carbon with a resin binder, or the like is used. A face thereof is processed with a conductive cover 84 such as a noble metal comprising gold coating or the like, or perovskite to increase the conductivity. Furthermore, the outside thereof is processed with a resin cover 86 using an adhesive material or the like so as to enable an insulation from the liquid fuel. These processes make the end plates 5 and 6 possible to improve in corrosion resistance, to obtain sufficient conductivity and, in addition, the processes prevent these plates from being short-circuited. Moreover, in order to increase the strength, the carbon plate 82 may be reinforced with carbon fiber or glass fiber.

In FIG. 4, a modified separator 100 is shown. On a surface 102 on the side of a fuel electrode, a plurality of vertical ducts 105 and, for example, two horizontal ducts 106 and 106′ are provided, while, on a surface 104 on the side of an air electrode, for example, horizontal ducts 107 are provided. Reference numeral 108 denotes a land provided within the ducts 107. Each land 108 is formed higher than the ducts 107 so that it contacts with an air electrode. Reference numeral 109 denote an air supply opening and reference numeral 110 an exhaust opening. These openings are, for example, provided on both sides i.e. the left and right sides of the separator 100, and top and bottom faces thereof are left for intakes of the liquid fuel. In the present specification, the terms such as lateral direction, from side to side are used for contrasting with vertical. As for the separator 60 and the modified separator 100 in the present embodiments, the length from side to side is made longer than the height in the vertical direction. This means, in FIGS. 2 and 4, the length is made longer than the height. By taking the dimensions in this manner, the traveling distance the liquid fuel must move in the difference of the relative density is shortened, thereby making a fuel supply easy.

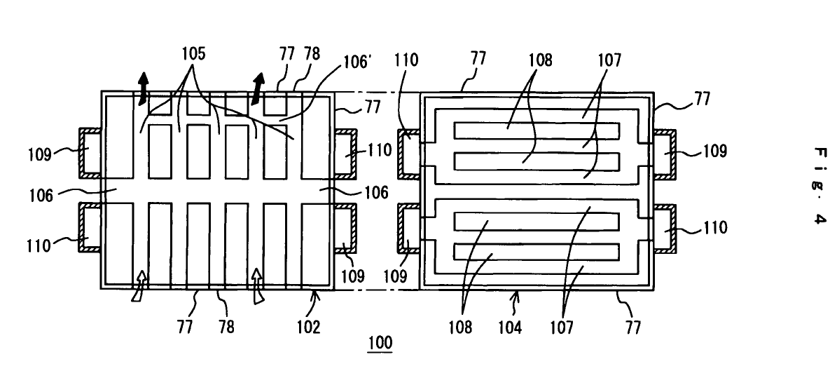

In FIG. 5, there is shown a state where the system is being operated while inclining the fuel tank 20. For example, it is likely in a practice that the liquid tank 20 is used with an inclination in the range of 5 degrees or less than that, or of 10 degrees or less than that. In FIG. 5, a liquid surface 23 where the fuel tank 20 is used while being inclined from the horizontal liquid surface level. As shown with a dashed dotted line in FIG. 5, when an exhaust part 90 is provided tentatively at only one place and is separated from the gas space 24 by the liquid surface 23, carbon dioxide does not flow into the exhaust part 90 but is remained within the fuel tank 20, thereby causing a pressure. In the embodiments, since water recovered is returned into the fuel tank 20, the pressure in the fuel tank 20 is further increased and thus the direct fuel cell system 2 is caused to stop. On the other hand, exhaust parts 25 and 26 are provided at a plurality of positions, for example two positions, in the longitudinal direction for the fuel tank 20. Especially, when these exhaust parts 25 and 26 are provided at a plurality of positions on an upper face of the fuel tank 20 in the longitudinal direction thereof, at least one of the exhaust parts 25 and 26 is remained above the liquid surface 23 and connected to the gas space 24 so that the continuation of discharging waste air is made possible. Incidentally, two exhaust parts 25 and 26 may be so communicated that the discharging of the waste air is performed through the exhaust part 92. However, in this case, essentially the two exhaust parts, 25 and 26, are still used.

When inclining the fuel tank 20, vertical ducts 66 and 105 of the separators 60 and 100 are also inclined from the vertical positions. When upper portions of these vertical ducts 66 and 105 come out of the liquid surface 23, it is no longer possible to discharge waste fuel from these ducts and thus they do not work as normal ducts. However, when horizontal ducts 68, 106 and 106′ are provided, it becomes possible to minimize the number of such ducts, not working as normal ducts, which is incapable of discharging waste fuel. In the embodiments, the exhaust parts 25 and 26 are provided at two or more positions while the horizontal ducts 68, 106 and 106′ are provided on the surfaces 62 and 102 of the separators on the side of the fuel electrode, thereby increasing an admissible range of inclination for the fuel tank 20. The range of inclination of the fuel tank 20 where a normal generation of power is made possible even when it is inclined is, for example, in the range of ±15 degrees for example, preferably ±10 degrees, or of ±5 degrees to be more specific.

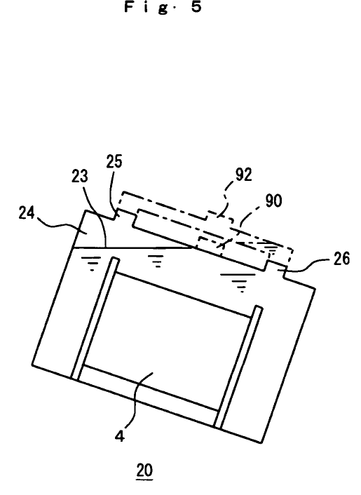

In FIG. 6, a modified direct fuel cell system is shown. Reference numeral 20 denotes the same fuel tank as the one previously described. The tank 36 for a high concentration of methanol and the water tank 42 are omitted in illustration. The blower 16 controls an amount of supplied air using the control unit 50, not shown in the figure, depending on an output voltage of the cell stack 4. The configurations other than those are the same as those in the embodiments shown in FIGS. 1 to 3 except those specially pointed out. Reference numerals 112, 114, and 116 denote heat exchangers, and reference numeral 118 a cooling fan. Air from the blower 16 is heated with the heat exchanger 112 and supplied to the cell stack 4, while air on an exhaust side is heat-exchanged with the liquid fuel 22 using the heat exchanger 114 and is thus cooled down. Subsequently, waste air is returned into the fuel tank 20; gas in the gas space 24 of the fuel tank 20 is cooled down using the heat exchanger 116; and air and carbon dioxide are discharged from a gas outlet 120 while preventing methanol or the like from evaporating.

In FIG. 7, a constitution for bubbling is schematically described as follows. Air in an air pipe 8 is partly distributed from a valve 14 into an air pipe 15. The air distributed therefrom moves upward in the liquid fuel from a bubbling mat 18, enters vertical ducts 66 of the cell stack 4, and is heated in a fuel electrode.

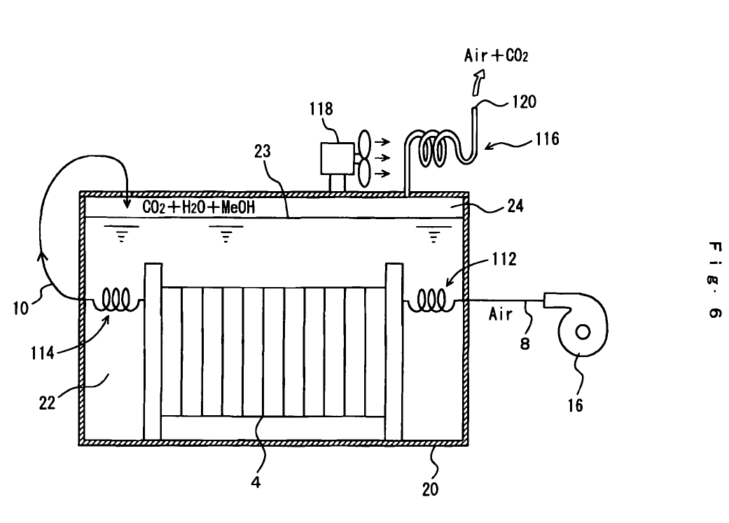

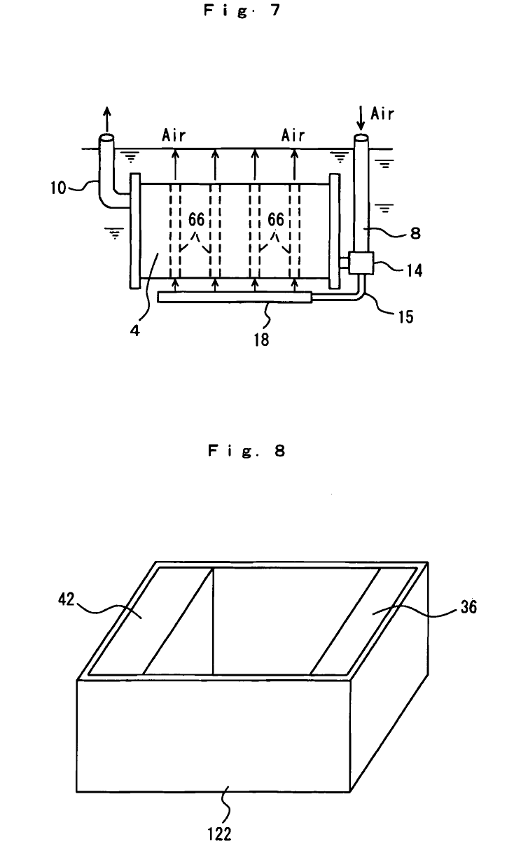

In the embodiment, the water tank 42 and the tank 36 for a high concentration of methanol are removably secured to the fuel tank 20 on the outside thereof so as to be integrated therewith. On the other hand, in FIG. 8, the water tank 42 and the tank 36 for a high concentration of methanol are secured to a fuel tank 122 on the inside thereof. In a gas space between them, the cell stack 4 and the liquid fuel 22 may be housed.

In FIG. 9, a direct fuel cell system 132 is shown as an modified embodiment. The configuration of the modified direct fuel cell system 132 is the same as that of the direct fuel cell system 2 in FIG. 1 except those specially pointed out. The same components as those in the previous figures are denoted by the same reference numerals. Reference numeral 134 denotes a housing. Reference numeral 136 denotes a water separator tank, which separates water contained in waste air by an adequate technique and recovers the water thus separated into the fuel tank 20. When the liquid level in the fuel tank 20 is high, the water is recovered into the water tank 42. While the water tank 42 may be attached to an upper part of the housing 134, this causes the height of the direct fuel cell system to be increased. In this modified embodiment, use of the water separation tank makes it easy to recover water into the fuel tank 20.

Second Embodiment

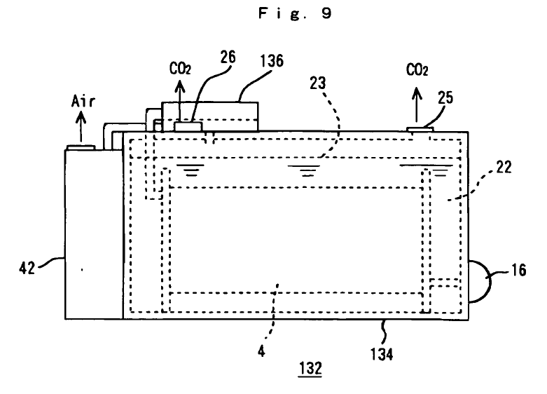

FIG. 10 shows an example of a cell structure for a direct fuel cell system in a second embodiment. FIG. 11 shows an example of a cell stack of the same. As shown in FIG. 10, in this cell structure, a pair of air electrode 212 and fuel electrode 213 are joined together with an electrolyte 211 interposed between the air electrode 212 and the fuel electrode 213, the electrolyte 211 comprising a proton conductive solid polymer electrolyte membrane, hence forming a membrane electrode assembly 210 (hereinafter referred to as MEA). While the electrode 212 is not shown in the figure, they are joined with the electrolyte 211 on the face opposite to the face thereof joining with the fuel electrode 213. A duct 223 for fuel supply is provided for supplying a liquid fuel to the side of the fuel electrode 213 and for discharging a reactant to the side of the fuel electrode 213. Furthermore, the MEA 210 is supported with two separator plates 220 to provide a duct 222 for air supply so that air is supplied to the side of the air electrode 212 and a reactant is discharged from the side of the air electrode 212. Incidentally, as shown in FIG. 10, on one face of the separator plate 220, the duct 223 for fuel supply is provided and, on the back thereof, the duct 222 for air supply is provided. The MEAs 210 are laminated with the separator plate 220 interposed therebetween whereby a cell stack 201 is formed as shown in FIG. 11. In the cell stack 201, a separator plate 220a where a duct 221 only for fuel supply is provided and a separator plate 220b where a duct 224 only for supplying air is provided are provided to outermost parts thereof. As for the separator plates 220, the separator plates 220a and 220b may be adhered so that each duct is reversed. Consequently, two kinds of the separator plates are available.

As shown in FIG. 11, the cell stack 201 has the ducts 221 and 223 for fuel supply both being straight and having openings in the vertical direction and the ducts 222 and 224 for air supply both being straight and having openings in the cross direction. A liquid fuel is supplied from upper and lower openings, and a reactant from the side of the fuel electrode 213 is discharged from an upper opening. Air is supplied from a front opening or a rear opening (in FIG. 11, a front one/one close to the reader) and a reactant from the side of the air electrode 212 is discharged from a rear opening or a front opening (in FIG. 11, a rear one/one being distant from the reader). While these ducts are arranged to orthogonally cross over one another, the arrangement of the ducts is not confined to that one.

MEA 210 is made as follows. Of the proton conductive solid polymer electrolyte membranes, a Nafion membrane (brand name is Nafion 117) made of du Pont, which is a general one as a perfluorosulfonic acid electrolyte membrane, is used as the electrolyte 211. On a gas diffusion layer of a carbon paper being impregnated with a PTFE solution for performing thereon a water repellent process, a catalyst paste which is obtained by mixing a PTFE resin, a Nafion solution (isopropanol solvent), and an air electrode catalyst where platinum fine particles are supported on carbon particles of acetylene black is applied. The gas diffusion layer with the catalyst paste thus applied thereon is dried and thereafter used as the air electrode 212. In addition, on the same gas diffusion layer, a catalyst paste which is obtained by mixing a PTFE resin, a Nafion solution (isopropanol solvent), and a fuel electrode catalyst where platinum-ruthenium fine particles are supported on carbon particles of acetylene black is applied. The gas diffusion layer with the catalyst paste thus applied thereon is dried and thereafter used as the fuel electrode 213. While, for the air electrode catalyst, one whose content of platinum fine particles is 40 wt % was used, an adequate one may be selected from among those whose contents of platinum fine particles are in the range of 10-70 wt %. While, for the fuel electrode catalyst, one whose content of platinum-ruthenium fine particles is 40 wt % and whose weight ratio of platinum to ruthenium is 2 to 1 was used, an adequate one may be selected from among those whose contents of platinum-ruthenium fine particles are in the range of 10-70 wt %; and from among those whose weight ratios of platinum to ruthenium are in the range of 5 to 1 to 1 to 2. A composition of a PTFE resin, a perfluorosulfonic resin and an air electrode catalyst and fuel electrode catalyst in a solution diffusing the catalysts may be arbitrarily determined. In this manner, the MAE was produced by joining the air electrode 212 and the fuel electrode 213 with the both faces of the electrolyte 211 with a hot pressing.

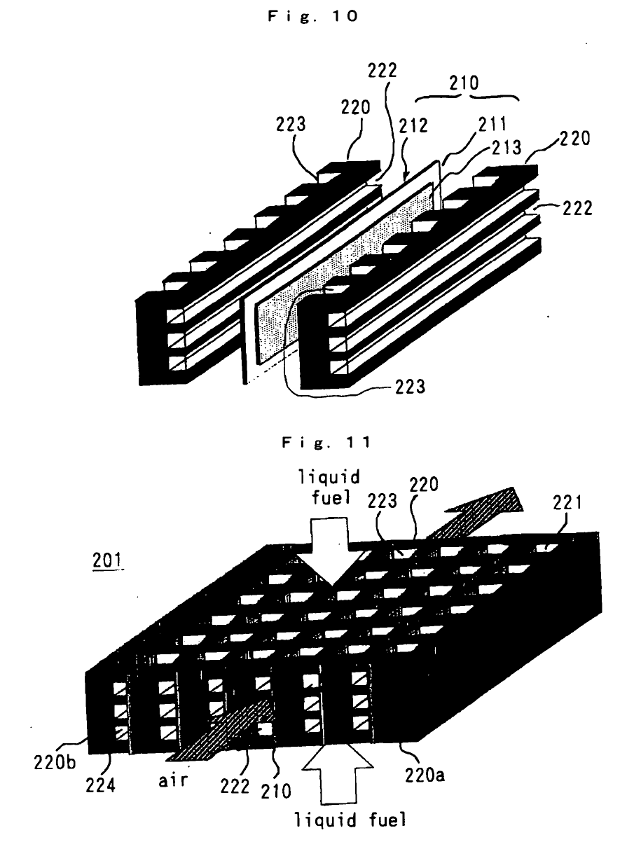

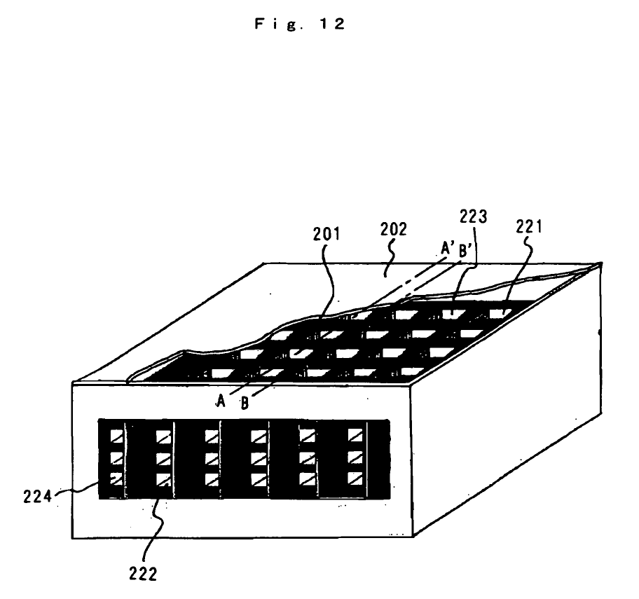

In the cell stack 201 of the direct fuel cell system of this embodiment, the ducts 221 and 223 for fuel supply are so made that the liquid fuel flows therethrough. In other words, as shown in FIG. 12, the cell stack 201 is disposed in a fuel tank 202 in a way that the ducts 221 and 223 for fuel supply are open in the fuel tank 202 which stores the liquid fuel. This causes the fuel tank 202 to also work as a container for the cell stack 201. Accordingly, as shown in FIG. 13(a) (a partial sectional view taken along line A-A′ of FIG.12), the liquid fuel flows into a space 223a being formed by the ducts 223 for fuel supply to be supplied with the fuel electrode 213 (FIG. 10), thereby discharging carbon dioxide being a reactant through an upper part. Due to this movement, a convection of the liquid fuel is generated and thereby makes it possible to supply the liquid fuel to the fuel electrode 213 with no intermittence. By providing a resupply opening for the liquid fuel to the fuel tank 202, when the concentration of the liquid fuel decreases due to a reaction, a fresh liquid fuel is supplied so that the system can be used without a stop.

The discharge carbon dioxide thus discharged becomes air bubbles in the liquid fuel and the air bubbles are stored in an upper portion of the fuel tank 202. However, by providing an exhaust opening at an upper part of the fuel tank 202, the air bubbles may also be discharged therethrough. Incidentally, by providing to the exhaust opening a water repellent porous means such as Teflon (registered trademark), it becomes possible to prevent the leaking of the liquid fuel from the exhaust opening.

In the direct fuel cell system, ducts 222 and 224 for air supply are made so as to cause air to flow therethrough. That is, as shown in FIG. 12, the ducts 222 and 224 for air supply are open to the atmosphere. An adhesion, a packing seal or the like is applied on the open parts so as not cause the liquid fuel from leaking to the outside, and the cell stack 201 is disposed in the fuel tank 202. Accordingly, as shown in FIG. 13(b) (a partial sectional view taken along line B-B′ of FIG.12), air flows into a space 224a being formed by the ducts 224 for air supply to be supplied to the air electrode 212, thereby discharging water being a reactant. By providing to the open parts a water repellent porous means such as Teflon (registered trademark), it becomes possible to prevent the leaking of the produced water.

In addition, the water thus discharged is caused to be absorbed into a water-absorbing means, recovered into a recovering cassette being separately prepared, or is returned into the fuel tank 202. However, there is also a choice where they are used in combination. For example, when returning the water into the fuel tank 202, if the amount of the liquid fuel in the fuel tank 202 is large, the water can be absorbed into the water-absorbing means without returning it into the fuel tank 202. When returning the water only into the fuel tank 202, it is necessary to control its amount according to the amount of the liquid fuel in the fuel tank 202.

There is a method for causing air to flow through the ducts 222 and 224 for air supply, by which an outer manifold structure is provided in the cell stack 201 without providing to the fuel tank 202 an open part which is open to the atmosphere, and air is forced, with a blower or a fan, to flow into the cell stack 201 in the fuel tank 202 through the piping of the manifold structure. This makes it possible to prevent the liquid fuel from leaking by applying a resin adhesion, a packing seal or the like on a connecter only between the outer manifold and the cell stack 201.

Furthermore, there is a method for causing air to flow through the ducts 222 and 224 for air supply, by which air can be supplied not only with the use of a natural diffusion or a natural convection but can also be forced to distribute with a blower or a fan. In this case, by providing a blower or a fan to the open which is open to the atmosphere, air may be supplied through this open part, or, by proving an inner manifold to each of separators 220, 220a and 220b for causing air to flow through, air may be supplied through an air supply opening which is communicated with this inner manifold. When providing the inner manifold, the depth of ducts for air supply the ducts being provided to the separators 220 and 220b is made small so that the thickness of the separators 220 and 220b can be made small. Hence, it is possible to scale down the direct fuel cell system with the output being maintained the same, while it is possible to increase the capacity of the direct fuel cell system with the dimensions maintained the same. By providing a water repellent porous means such as Teflon (registered trademark) to the open parts and the air supply opening, it becomes possible to prevent the leaking of the water produced due to the reaction.

Incidentally, by providing separately to the cell stack an open part of a duct for air supply the open part thereof being open to the atmosphere and an open part of a duct for fuel supply the open part thereof being open to the fuel tank, air and the liquid fuel can be supplied from the respective open parts without being mixed each other.

Third Embodiment

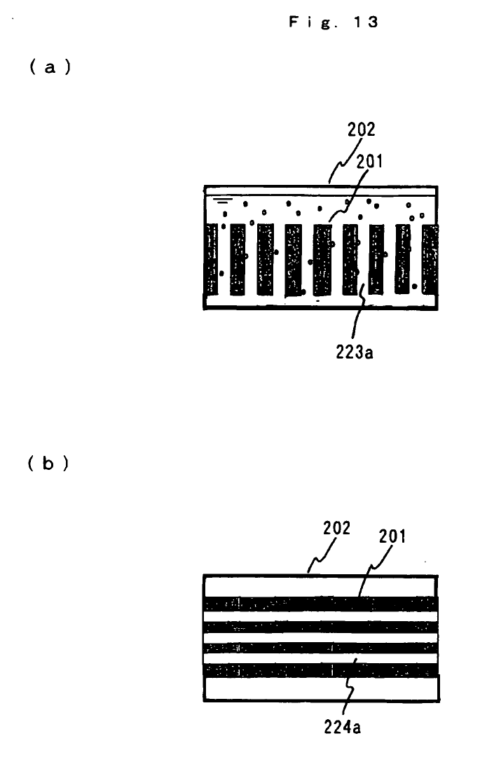

In FIGS. 14-29, a third embodiment and its modified embodiments are shown. In these figures, reference numeral 302 denotes a direct fuel cell system which directly supplies a liquid fuel such methanol-water to a fuel electrode. Reference numeral 304 denotes a fuel cell stack. The fuel cell stack 304 is formed by layering a plurality of MEAs with separators interposed therebetween, each MEA being formed with a proton conductive solid polymer electrolyte membrane on both faces of which a fuel electrode and an air electrode are provided. Reference numeral 306 denotes a fuel tank. The fuel tank 306 stores a liquid fuel such as methanol-water, in which tank a fuel cell stack 304 is disposed and is submerged in the liquid fuel(under the surface thereof). Reference numeral 308 denote an air supply duct and reference numeral 310 an air discharge duct. Ducts, which are communicated with the ducts 308 and 310, are provided to the separators and the MEAs of the fuel cell stack 304. On the side of an air electrode for each separator, a duct for air supply not shown in the figure is provided, while, on the side of a fuel electrode for each separator, a fuel supply duct, which communicates from the lower side of the fuel tank 306 to the upper side thereof, is provided so that a fuel is supplied to a fuel electrode with a natural convection in the liquid fuel in the liquid tank 306. A waste fuel and carbon dioxide are discharged into the liquid fuel in the fuel tank 306 through an upper part of the fuel supply duct.

Reference numeral 312 denotes a blower for air supply and reference numeral 314 a filter for removing dust in the air. Use and disuse thereof are freely chosen. The air, which is blown into the air supply duct 308 from the blower 312, is supplied into the fuel cell stack 304, while waste air enters a radiator 316 through the air discharge duct 310, and is cooled down as needed with an air blow from a fan 318 to be separated into waste air and water using a vapor-liquid separator 320. However, it is not necessary to provide the blower 312, the radiator 316, the fan 318 and the vapor-liquid separator 320. As a separator for the vapor-liquid separator 320, there may be used one which separates gas and liquid using a vapor-liquid membrane such a porous polymer membrane, one which separates mist-like water from an air flow by colliding it against a baffle, or the like. These separators can be changed as needed within known technologies. Furthermore, the structure of the vapor-liquid separator 320 may be made as one, which is capable of maintaining a constant quantity of liquid in the fuel tank 306.

A water recovering hole 322 of the vapor-liquid separator 320 is preferably disposed under the liquid surface in the fuel tank 306 so that, for example, water is discharged in the vicinity of the bottom of the fuel tank. This is effective to pressurize a waste water / waste air line 324 which is extended from the vapor-liquid separator 320. That is, a pressure applied by the blower 312 is partly applied on the waste water/waste air line 324 so that it becomes possible to discharge part of water the water being separated with the vapor-liquid separator 320 and the waste air into a waste liquid reservoir 355 of a fuel cassette 350 without using a liquid supply pump.

Reference numeral 326 denotes a fuel pump which supplies the fuel tank 306 with a liquid fuel such as methanol-water in an elastic bag 352 (fuel reservoir) of the fuel cassette 350. When an elastic bag having elasticity is used for the elastic bag 352, the liquid fuel is supplied to the fuel tank 306 with a force generated by shrinking of the elastic bag. Therefore, in this case, the fuel pump 326 may be omitted. The fuel pump 326 may also be omitted when supplying the liquid fuel to the fuel tank 306 with the pressure which is applied on the fuel cassette 350 through the waste water / waste air line 324. Reference numeral 328 denotes a fuel supply line.

Reference numeral 330 denotes a CPU (Control Processing Unit), and reference numeral 332 a carbon dioxide outlet which is provided to the fuel tank 306. On the carbon dioxide outlet 332, a water-repellent and porous polymer membrane or the like is used to discharge to the outside carbon dioxide produced on a fuel electrode. Reference numeral 334 denotes a level meter which measures the height of the liquid surface in the fuel tank 306, and reference numeral 336 a methanol sensor which measures the fuel concentration of a fuel or the like and which may be replaced by a sensor for dimethylether, isopropanol or the like. The CPU 330 controls the fan 318 using an output of the level meter 334. This control causes the extent of cooling in the radiator 316 to change, according to which an effectiveness of the vapor-liquid separator 320 changes whereby the position of the liquid surface in the fuel tank 306 can be maintained within a predetermined range. Further, using a signal form the methanol sensor 336, the fuel pump 326 is controlled that the fuel concentration is maintained within a predetermined range.

A control of the liquid surface level in the fuel tank 306 is described. When the liquid surface is lowered, waste air is cooled down with the radiator 316 by activating the fan 318 whereby the separation of water in the vapor-liquid separator 320 is easily performed. A larger amount of produced water is recovered into the fuel tank 306 to raise the liquid surface. When the liquid surface in the fuel tank 306 is raised, it causes the fan 318 to stop, the temperature of the waste air in the vapor-liquid separator 320 to raise, and the amount of water which is returned to the fuel tank 306 to decrease. Part of the separated water is recovered in the waste liquid reservoir 355 of the fuel cassette 350 using the pressure from the blower 312. In FIG. 14, a signal PI denotes a control signal of the fuel pump 326, a signal P2 a control signal of the fan 318, and a signal P3 a control signal of the blower 312.

The fuel cassette 350 is provided with the elastic bag 352 and the waste liquid reservoir 355, and is made that the elastic bag 352 being colored is viewed through a viewing window 354. Reference numeral 356 denotes a chemical filter such as a sheet-like active carbon. The chemical filter 356 adsorbs impurities in the air such as methanol, formic acid, formaldehyde and methyl formate, which are evaporated through an opening being provided to the case of the fuel cassette 350, via a gas permeable membrane 358 such as a porous polymer membrane.

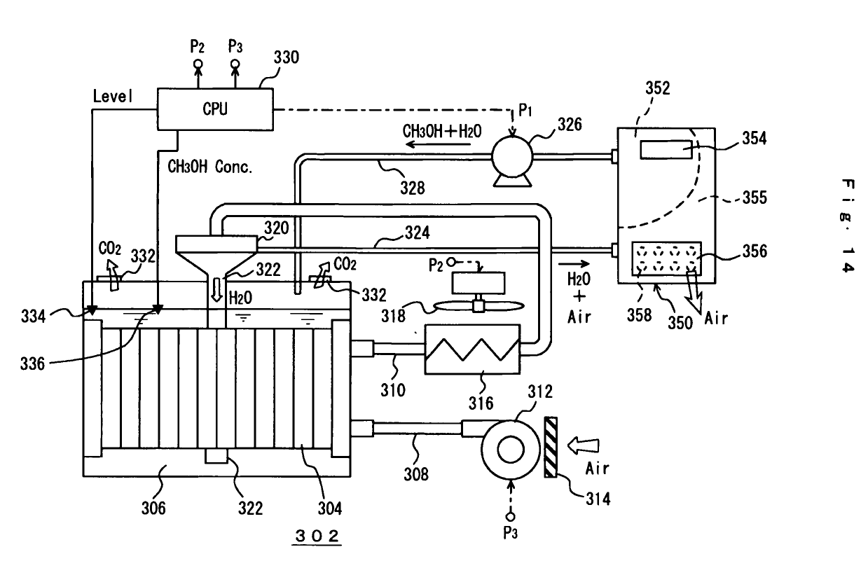

In FIGS. 15-20, embodiments of the fuel cassette are shown. Reference numerals 360 and 362 denote a pair of connectors. The connector 360 is used for supplying a fuel from the elastic bag 352, while the connector 362 is used for recovering a waste fuel into the waste liquid reservoir 355. In FIG. 15, with reference to the fuel cassette 350, since the elastic bag 352 is initially swelled with the fuel being filled, when the connector 360 is connected to a connector on the side of the direct fuel cell system 302, supplying of the fuel is performed by an action of a pressure being generated by the elastic bag 352 so that the fuel pump 326 is not necessary. Then, a space being generated when the elastic bag 352 shrinks becomes the waste liquid reservoir 355. As for the material of the elastic bag 352, for example, silicon rubber, butyl rubber, latex rubber or the like is used. As for the material of the case of the fuel cassette 350, polypropylene, polyethylene, PET or the like is used. Incidentally, recovered water may be immobilized though filling of a water adsorbing resin or the like in the waste liquid reservoir 355.

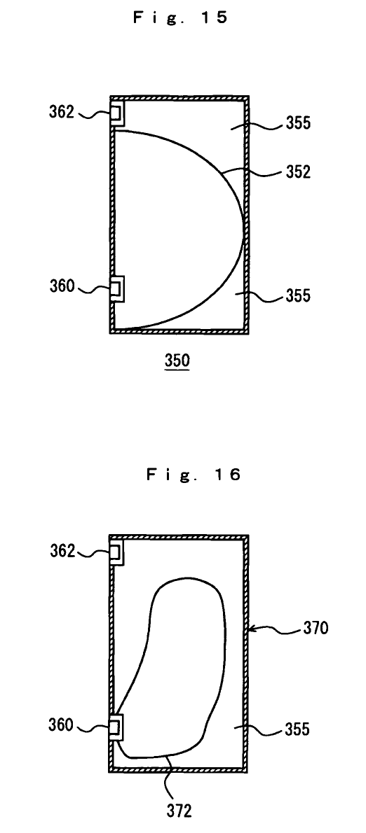

In FIG. 16, with reference to a fuel cassette 370, a liquid fuel-impermeable and flexible bag 372 is used and the material thereof to be used is polypropylene, polyethylene, nylon, fluorescing or the like. Other than the above mentioned, there is nothing different from the fuel cassette 350 in FIG. 15.

In FIG. 17, with reference to a fuel cassette 374, a bellows-like bag 376 made of a fuel-impermeable polymer material is used, and shrinks in response to the supplying of liquid fuel from the connector 360.

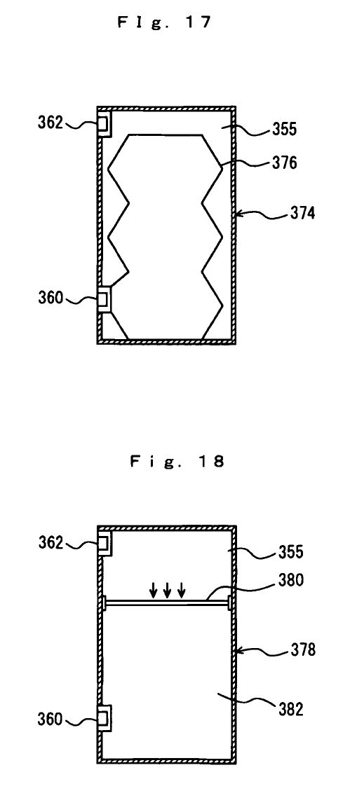

In FIG. 18, with reference to a fuel cassette 378, a movable wall 380 is placed between a fuel reservoir 382 and a waste liquid reservoir 355 in a way that the movable wall 380 moves toward the side of the connector 360 with a sucking force generated by a fuel pump and a pressure of the water recovered in the waste liquid reservoir 355.

In FIG. 19, with reference to a fuel cassette 384, reference numeral 386 is an immovable partition, which separates the waste liquid reservoir 355 and the flexible bag 372, whereby the sealing of the connector 360 is prevented from being difficult due to increasing of the temperature of the liquid fuel in the bag 372, the increasing thereof being caused by the temperature of the recovered water in the waste liquid reservoir 355.

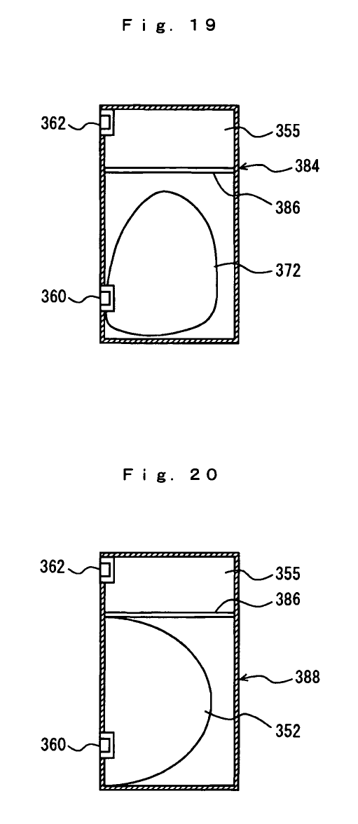

In FIG. 20, with reference to a fuel cassette 388, reference numeral 386 is the same immovable partition as the one described above, and the elastic bag 352 having elasticity is placed on the side of the connector 360 with respect to the immovable partition 386.

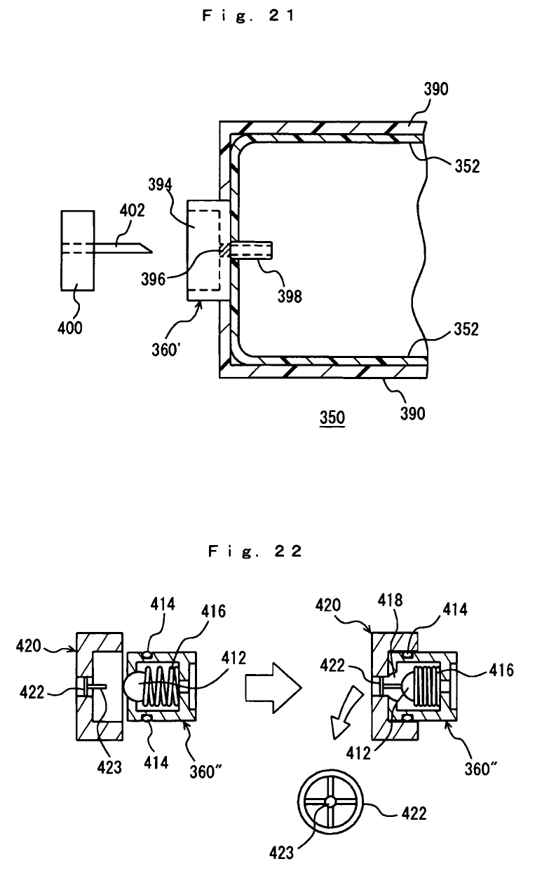

In FIG. 21, a connector 360′ using a hollow needle 402 is shown. Reference numeral 390 denotes a case of the fuel cassette 350, reference numeral 394 a fitting concave part, reference numeral 396 a sealing part made of rubber, plastic or the like, and reference numeral 398 a needle cover. Reference numeral 400 denotes a connector on the side of the direct fuel cell system, and the hollow needle 402 is passed through the sealing part 396 so as to be connected to the fuel cassette 350 and the direct fuel cell system. Such connector 360′ is inexpensive. However, when it is intended to repeatedly use the fuel cassette 350, it is preferable that the connector 360′ together with the sealing 396 is replaceable.

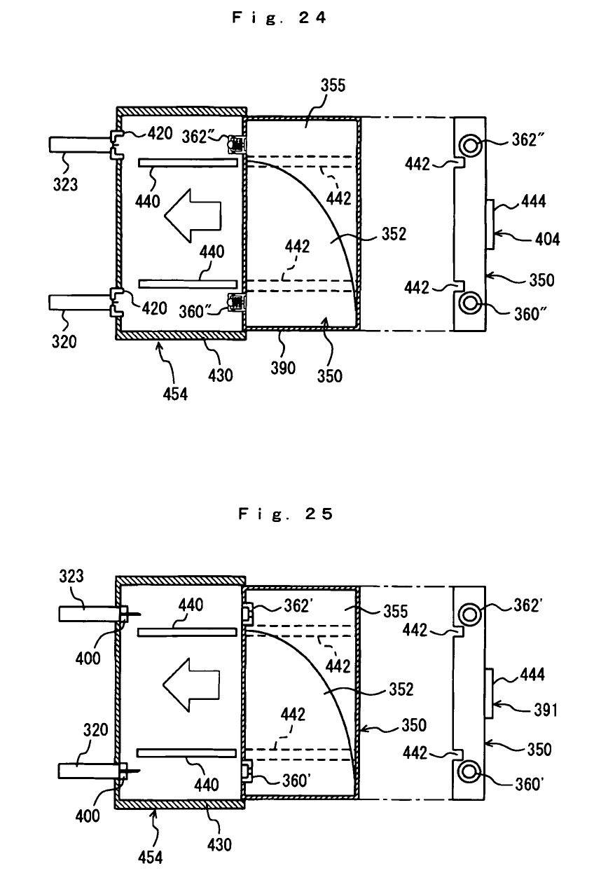

In FIG. 22, a connector 360″ using a ball valve 412 is shown. Reference numeral 414 denotes a fluid-tight 0-ring, reference numeral 416 a spring which works to push the ball valve 412 to the side of the an opening 418, reference numeral 420 a connector on the side of the direct fuel cell system, reference numeral 422 a fastening ring, and reference numeral 423 a pin for the fastening ring 422. The pin 423 is fixed to the connector 420 with the fastening ring 422. When the connector 360″ is pressed into the connector 420, the pin 423 causes the ball valve 412 to go in reverse so that the connectors 360″ and 420 are connected. In this case, the connector 360″ may be provided on the side of the direct fuel cell system and the connector 420 on the side of the fuel cassette 350. In FIGS. 21 and 22, connectors 362′ and 362″ for waste liquid recovery are also arranged just like the connectors 360′ and 360″ for fuel supply (FIGS. 24 and 25).

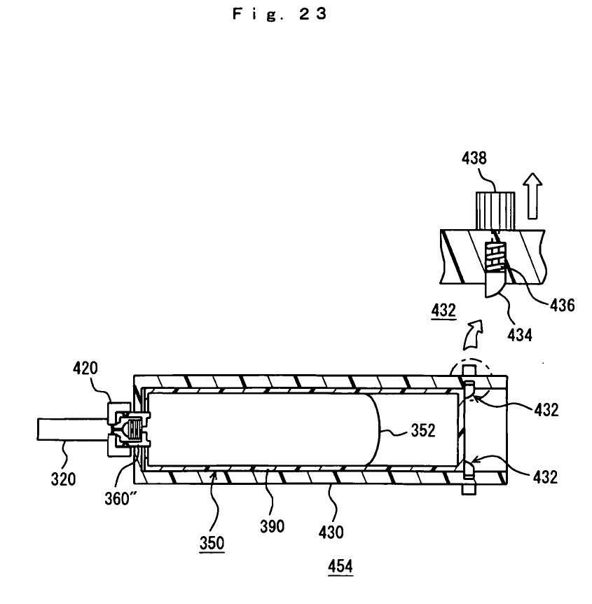

FIG. 23 shows a schematic view in which the fuel cassette 350 is loaded on a cassette area 454 of the direct fuel cell system. The fuel cassette 350 is housed in a cassette housing part 430 of the cassette area 454, an end of the outlet side of which is for example fixed vertically with a stopper 432. The stopper 432 comprises a locking piece 434, an energizing spring 436 which causes the locking piece 434 to be pushed out toward the rear end of the fuel cassette 350 and an operation part 438 which is connected to the locking piece 434. When raising the operation part 438, the locking piece 434 goes in reverse, and thereby the fuel cassette 350 is detached. When loading the fuel cassette 350, an action of the spring 436 causes the locking piece 434 to protrude, locking the connectors 360′ and 360″, whereby the leaking of liquid from the connectors 360′, 360″ and the like is prevented. Furthermore, the locking piece 434 has a curved shape on the outlet side, and, since the inner side is orthogonal to the wall of the cassette housing part 430, no friction is generated when the fuel cassette 350 is pressed in.

As shown in FIGS. 24 and 25, guide grooves 442 are provided on two places, for example, of the top face, and on the bottom face and a side face of the fuel cassette 350, and are engaged with protruding guides 440 which are provided to the cassette housing part 430. Thus, when loading the fuel cassette 350 on or detaching the same from the cassette housing part 430 through the swinging of the fuel cassette 350, the fuel cassette 350 is securely guided so that a firm connection for the connectors 360′, 360″ and the like is assured. A concavity/convexity 444 is provided on surfaces 404 and 391 of the fuel cassette 350 so that it works as a hook when detaching the fuel cassette 350 from the cassette housing part 430.

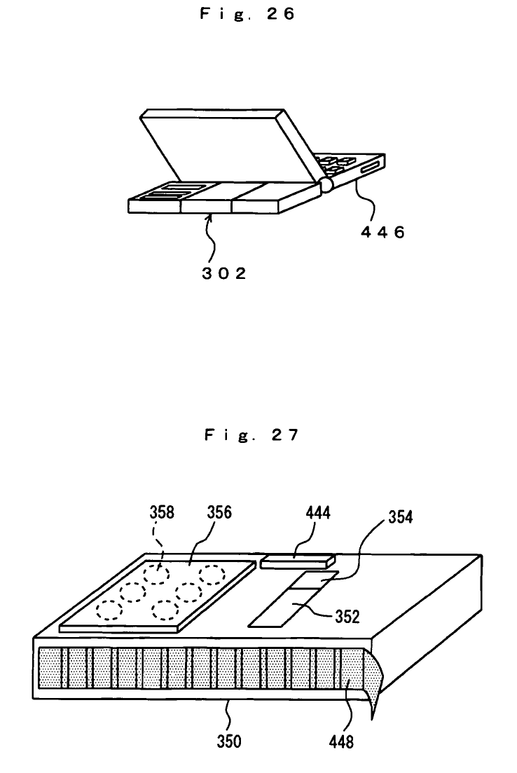

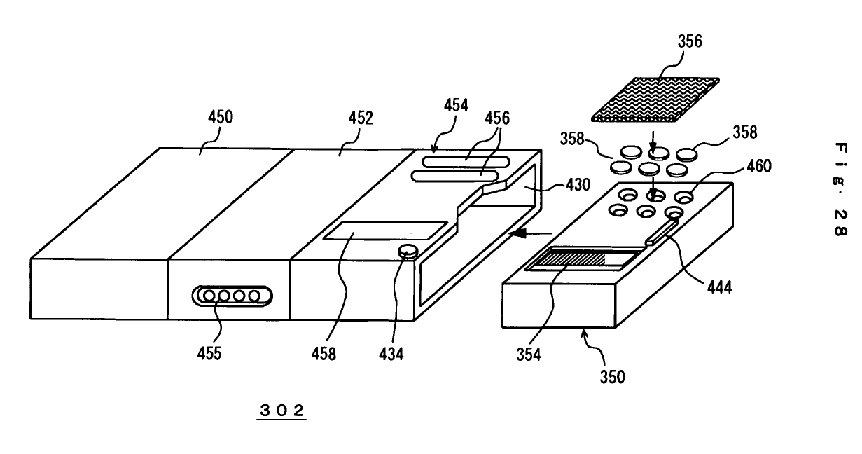

As shown in FIG. 26, a direct fuel cell system 302 is used as a portable power source by loading it on a personal computer 446 or the like, as a power source for emergency or as one in outdoor. In FIG. 27, reference numeral 448 denotes a sealing tape for sealing a side of the fuel cassette 350 where connectors are provided, whereby the leaking or the evaporation of a fuel before using is prevented.

As shown in FIG. 28, the concavity/convexity 444 is provided on a position of the fuel cassette 350, the position thereof corresponding to that (an upper-rear end of the fuel cassette 350) on the outlet side of the cassette housing part 430 of the direct fuel cell system 302. This allows a user to easily detach the fuel cassette 350 from the cassette housing part 430 by hooking with his/her finger. FIG. 28 shows a schematic view in which a colored elastic bag is seen through a viewing window 354.

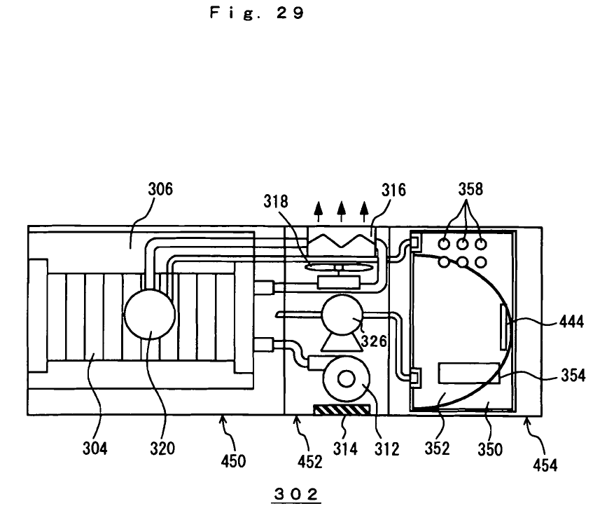

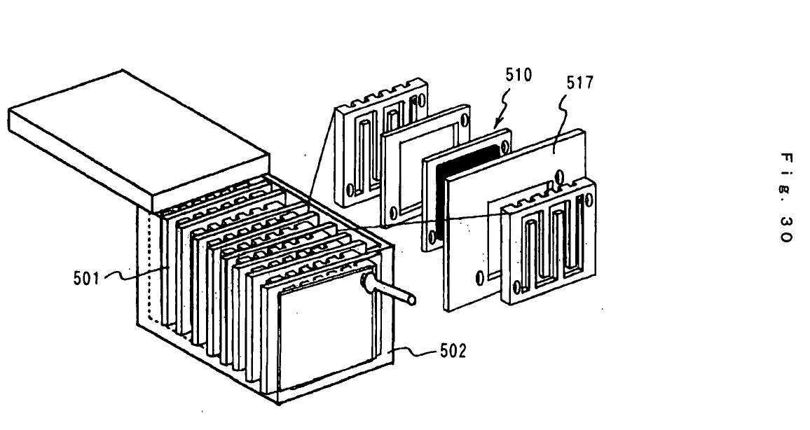

As shown in FIGS. 28 and 29, the direct fuel cell system 302 is provided with a stack area 450, an auxiliary area 452 and a cassette area 454. In the stack area 450, as shown in FIG. 29, the fuel tank 306 is provided and the fuel cell stack 304 is housed. In the auxiliary area 452, as shown in FIG. 29, the CPU, the blower 312, the fuel pump 326 the radiator 316, the fan 318 and the like are provided, and are made possible to be connected to a personal computer or the like through connectors 455 as shown in FIG. 28. In the cassette area 454, openings 456 are provided as shown in FIG. 28 so that the air, which passes through the gas permeable membrane 358 and the chemical filter 356 of the fuel cassette 350, is discharged. The chemical filter 356 may be provided on the side of the openings 456. However, it is not preferable since the life of the filter is limited. Reference numeral 458 denotes a window which is used to check the elastic bag 352 shown in FIG. 29, having housed a fuel, through the viewing window 354 of the fuel cassette 350. Reference numeral 460 denotes an evaporation opening which is provided to a case of the fuel cassette 350.

In the embodiment, the following effects are obtained.
(1) Since water or the like produced in the direct fuel cell system is recovered for disposal, it is possible to provide a compact direct fuel cell system which does not need a waste liquid tank and which is suited to portable electronics such as personal computers and personal digital assistances.
(2) The supplying of a fuel becomes easy by using the fuel cassette, and, by recovering water produced on an air electrode, the liquid level in the fuel tank can be maintained, and the processing of waste water also becomes easy.
(3) It becomes easy to check the remaining amount of the fuel with eyes through a viewing window.
(4) Produced formic acid, remaining methanol and the like can be safely disposed since they are disposed with the fuel cassette. An absorbing resin or the like may be disposed in the waste liquid reservoir for making it easy to recover waste liquid into the waste liquid reservoir
(5) A waste liquid pump becomes unnecessary since, for the recovering of waste liquid, it is possible to use a pressure from a blower for air supply. An application of this pressure on the elastic bag 352 or the like also makes the supplying of a fuel possible.
(6) When placing the elastic bag 352, the flexible bag 372 or the like in the fuel cassette, a space for a waste liquid reservoir is increased as a fuel is consumed, allowing the space within the fuel cassette to be effectively used. It becomes easy to recover the waste liquid. Use of the elastic bag makes it possible to supply a fuel with a force generated by the shrinking of the elastic bag, hence eliminating the use of the elastic bag.
(7) The operation condition of the radiator can be controlled so as to maintain the liquid surface in the fuel tank within a predetermined range.
(8) By discharging, from the waste liquid reservoir, air, vapor or the like through the gas permeable membrane 358 and the chemical filter 356, it becomes possible to recover a large quantity of waste liquid and to remove methanol and formic acid.
(9) By providing a removable or immovable partition between a waste liquid reservoir and a fuel reservoir in the fuel cassette, it becomes possible to decrease a frequency of the situation where the temperature of the fuel in the fuel reservoir increases due to the presence of the waste liquid. For this to be workable, for example, the partition may be made to be adiabatic, or, as shown in FIGS. 19 and 20, the partition 386 and the elastic bag 352 or the like may be separately prepared.
(10) By providing guides on the bottom and side faces of the fuel tank or the top face thereof, the detaching and loading of the fuel cassette is made easy.
(11) A secure connection is made possible by using the hollow needle, the ball valve and the like, and thereby it becomes possible to prevent a fuel from leaking before loading the fuel cassette.
(12) Proving of the stopper makes it possible to firmly load the fuel cassette into the cassette housing part so that a more stable connection at a connector is achieved.
(13) Use of the sealing tape makes it possible to prevent a liquid fuel from evaporating before loading the fuel cassette, to prevent dust from sticking to a connector, or the like.
(14) Providing of the concavity/convexity allows one to easily detach the fuel cassette from the fuel housing part.
(15) By causing the methanol concentration in the fuel reservoir to be in the range of 20-100 wt % or preferably in the range of 40-100 wt %, it becomes possible to recover into the waste liquid reservoir water content, the amount of which depends on water content to be supplied from the fuel reservoir and water content produced on an air electrode.

Describing as a supplement with respect to the embodiment, the description on the elastic bag 352 can be used with no change for the flexible bag 372, except the part where the elastic bag 352 is an elastic one. As for a proton conductive solid polymer electrolyte membrane or electrodes′ material, known ones may be properly used. In addition, the fuel cell stack may be separated from the fuel tank so as to be independent, or a fuel may be directly supplied from the fuel reservoir of the fuel cassette without providing a fuel tank. In this case, for example, both a waste fuel from the fuel reservoir and water content from an air electrode are recovered into the fuel reservoir. Furthermore, by providing three areas which are a waste liquid reservoir, a high concentration fuel reservoir and a fuel reservoir, and by using the fuel reservoir as the fuel tank, a high concentration fuel is resupplied from the high concentration fuel reservoir to the fuel reservoir so as to maintain the fuel concentration within a predetermined range and thus the fuel may be directly supplied from the fuel reservoir to a fuel electrode. Now, assuming that the methanol concentration in the high concentration fuel reservoir is for example 20 wt %, it becomes possible to maintain the methanol concentration on the fuel tank to be almost constant by recovering a waste fuel from the fuel electrode, for example, in the fuel reservoir and also by recovering water content from the air electrode in the waste liquid reservoir. A water tank is provided to the fuel cassette. When the liquid surface level in the fuel tank is lowered while not operating the direct fuel cell system for a long period of time, the water in the water tank can be also used to adjust the liquid surface level.

Forth Embodiment While not particularly mentioning up to here, it is preferable not to add acid such as sulfuric acid, in a liquid fuel such as methanol-water. A side reaction on a fuel electrode produces formic acid, propionic acid, formaldehyde and the like. Organic acid such as formic acid and propionic acid cause the fuel to be slightly conductive. When the liquid fuel becomes conductive, an electric field generated by the cell stack causes an electric corrosion on a fuel electrode of an MEA. Thus, active carbon, zeolite and the like are added in the fuel or is placed therein to contact with the liquid fuel so that acid such as formic acid is removed from the liquid fuel. This also has an effect in removing from the liquid fuel a hazardous substance such as formaldehyde.

There were prepared a fuel where 1 M solution of sulfuric acid was added into a liquid fuel (1M methanol-water); a fuel where formic acid was added into the liquid fuel of IM methanol-water to be adjusted to PH2 (the concentration of formic acid is approximately 1M); and a fuel where sulfuric acid and formic acid were not added. Subsequently, separators having carbon property were placed in the above fuel that they face each other and stay 1-10 cm away from each other. A direct current of 3V or 6V was applied between the separators and the current flowing between them was observed. The current did not flow in the liquid fuel where neither formic acid nor sulfuric acid was added, and the amount of current flow for the fuel having 1M of formic acid reached 30 to 100 times more than that for the fuel having formic acid of PH2.

FIG. 30 shows an embodiment in which a liquid junction is prevented with a packing 517. Reference numeral 501 denotes a fresh cell stack, reference numeral 502 a fuel tank, reference numeral 510 an MEA, and reference numeral 517 an insulative packing which is disposed between a fuel electrode of the MEA and a separator. All others are the same as those in the first embodiment. In this embodiment, when acid is accumulated in the liquid fuel, use of the packing 517 enables the preventing of a liquid junction. In addition, by performing insulating coating with synthetic resin on the bottom and side faces of a groove for fuel supply and that for air supply of a separator, it becomes possible to prevent the degradation of the characteristic of the MEA due to liquid junction and short-circuit current.

What is claimed is:

1. A direct fuel cell system in which a cell stack is formed by serially connecting a plurality of unit cells with separators, each unit cell being formed by a proton conductive solid polymer electrolyte membrane on one face of which a fuel electrode is provided and on the other face of which an air electrode is provided, in a way that a separator is interposed between the unit cells, the cell stack being operable with a liquid fuel, wherein
the cell stack is disposed in a fuel tank so that at least part of the cell stack is submerged under a liquid surface of the liquid fuel in the fuel tank;
a duct for fuel supply is provided to a surface of the separator on the side of the fuel electrode thereof, both ends of the duct being placed to be submerged under the liquid surface of the liquid fuel, the liquid fuel in the fuel tank being naturally supplied to the fuel electrode; and
a duct for air supply is provided to a surface of the separator on the side of the air electrode thereof.

2. The direct fuel cell system of claim 1, wherein an exhaust part is provided to a top face of the fuel tank; carbon dioxide being produced on the fuel electrode is discharged through the exhaust part; and a duct for air supply is provided to a surface of the separator on the side of the air electrode thereof whereby air outside the fuel tank is supplied to the air electrode from a blower or a fan.

3. The direct fuel cell system of claim 2, wherein, depending on an operation condition of the fuel cell, an amount of air being supplied from the blower or the fan is controlled with a control means.

4. The direct fuel cell system of claim 1, wherein an exhaust pipe for discharging exhaust from the duct of the separator for air supply to the outside of the fuel tank is provided, exhaust from the exhaust pipe being heat exchanged, and, on the basis of a liquid level in the fuel tank, water being recovered through the heat exchange is either discharged in a water tank or is returned into the fuel tank.

5. The direct fuel cell system of claim 2, wherein an air supply pipe for supplying air from the blower or the fan to the separator is provided and valves are provided respectively to the exhaust pipe and the air supply pipe whereby the respective valves close when a fuel cell stops so that the ducts of the cell stack for air supply are maintained to be airtight.

6. The direct fuel cell system of claim 1, wherein an air pipe and a valve for performing bubbling of air into the fuel of the fuel tank from the bottom of the cell stack are provided and air is supplied to the ducts of the cell stack for fuel supply in cold starting.

7. The direct fuel cell system of claim 1, wherein a gas space, which remains above the liquid surface in the fuel tank, is provided and a plurality of exhaust parts, being placed at different horizontal positions, are provided to top part of the fuel tank so that at least one of the exhaust pipes contact with the gas space when the fuel tank is inclined.

8. The direct fuel cell system of claim 1, wherein the ducts for fuel supply are disposed in two dimension on the surface of the separator on the side of the fuel electrode.

9. The direct fuel cell system of claim 1, wherein both ends of the duct of the separator for air supply are connected to the atmosphere so as to cause air to be naturally supplied to the air electrode.

10. The direct fuel cell system of claim 1, wherein the cell stack is entirely dipped in the liquid fuel.

11. The direct fuel cell system of claim 9, wherein both ends of the duct for air supply and both ends of the duct for fuel supply are provided to different surfaces of the cell stack.

12. The direct fuel cell system of claim 1, wherein the fuel tank also works as a housing for the cell stack.

13. The direct fuel cell system of claim 1, wherein a re-supply opening for the liquid fuel is provided to the fuel tank.

14. The direct fuel cell system of claim 1, wherein the liquid fuel is methanol aqueous solution.

15. The direct fuel cell system of claim 1, wherein the liquid fuel is a mixture of organic solvent and water, and is added with no acid.

16. The direct fuel cell system of claim 1, wherein a member, which adsorbs or decomposes acid produced by a side reaction in the cell, is provided to contact with the fuel.

17. The direct fuel cell system of claim 1, wherein an insulation member, which is insulative and protruded out of an edge of the cell stack, is provided.

18. The direct fuel cell system of claim 17, wherein the insulation member is a packing being provided between the separator and the electrode.

19. The direct fuel cell system of claim 1, wherein the fuel is resupplied to the fuel tank from the fuel cassette, and a fuel reservoir and a waste liquid reservoir are provided to the fuel cassette so that water, which is brought out of the air electrode of the fuel cell together with waste air, is recovered into the waste liquid reservoir.

20. The direct fuel cell system of claim 19, wherein air is supplied to the air electrode from the blower or the fan, and a pressure from the blower or the fan the pressure acting on the waste air from the air electrode is used to recover water into the waste liquid reservoir of the fuel cassette.

21. The direct fuel cell system of claim 19, wherein part of the water being recovered into the waste liquid reservoir of the fuel cassette, or impurity being contained in the waste air is processed with a chemical filter and is thereafter evaporated or discharged to the outside.

22. The direct fuel cell system of claim 19, wherein a means for discharging waste air from the waste liquid reservoir is provided.

23. The direct fuel cell system of claim 19, wherein, depending on the liquid surface level in the fuel tank, the water being brought out of the air electrode together with the waste air is selectively recovered either into the waste liquid reservoir of the fuel cassette or into the fuel tank.

24. The direct fuel cell system of claim 19, wherein a vapor-liquid separator for separating water from the waste air from the air electrode is provided, and part of the water being separated with the vapor-liquid separator is recovered into the waste liquid reservoir of the fuel cassette.

25. The direct fuel cell system of claim 24, wherein the fuel is submerged in the fuel of the fuel tank; part of water content in the waste air from the air electrode is refluxed into the fuel tank via the vapor-liquid separator; and a gas outlet is provided to the fuel tank whereby carbon dioxide is discharged from the fuel electrode.

26. A fuel cassette for a direct fuel cell system, wherein a fuel reservoir being freely connectable to a direct fuel cell system and a waste liquid reservoir for storing waste water from the direct fuel cell system are provided, and part of water content being recovered in the waste liquid reservoir or impurity being contained in waste air is processed with a chemical filter and is thereafter evaporated or discharged to the outside.

27. The fuel cassette for a direct fuel cell system of claim 26, wherein a viewing window is provided to a case of the fuel cassette so as to check the fuel reservoir with eyes.

28. The fuel cassette for a direct fuel cell system of claim 26, wherein a swing guide for detaching and loading is provided in the direct fuel cell system.

29. The fuel cassette for a direct fuel cell system of claim 26, wherein a concavity/convexity part, which works as a hook when detaching from the direct fuel cell system, is provided.
